(19) United States
(12) Patent Application Publication
(10) Pub. No.: US 2014/0101234 A1
(43) Pub. Date: Apr. 10, 2014

(54) MULTI-CLOUD COMMUNICATION SYSTEM

(71) Applicant: NATIONAL CHENG KUNG UNIVERSITY, Tainan City (TW)

(72) Inventors: Chiang LEE, Tainan City (TW); Chao-Hsien HSIEH, New Taipei City (TW); Nai-Ying KO, Kaohsiung City (TW)

(73) Assignee: NATIONAL CHENG KUNG UNIVERSITY, Tainan City (TW)

(21) Appl. No.: 13/728,602

(22) Filed: Dec. 27, 2012

(30) Foreign Application Priority Data
Oct. 9, 2012 (TW) 101137276

(51) Int. Cl. H04L 29/06

(52) U.S. Cl. CPC H04L 67/42
USPC 709/203

(57) ABSTRACT

A multi-cloud communication system includes a plurality of clouds, each of which has a cloud server and a plurality of servers connected with the cloud server. The cloud server has a service information of the servers. When a first cloud server of a first cloud transmits a request information to a second cloud server of a second cloud, the second cloud server determines a level relationship between the first and second clouds, and acquires a target data from at least a second server of the second cloud according to the request information and the service information. The target data is encoded according to the level relationship, and then transmitted to at least a first server of the first cloud through the second cloud server and the first cloud server. The first server, according to the level relationship, decodes the encoded target data to obtain the target data.

### CROSS REFERENCE TO RELATED APPLICATIONS

This Non-provisional application claims priority under 35 U.S.C. §119(a) on Patent Application No(s). 101137276 filed in Taiwan, Republic of China on Oct. 9, 2012, the entire contents of which are hereby incorporated by reference.

### BACKGROUND OF THE INVENTION

1. Field of Invention

The invention relates to a communication system and, in particular, to a multi-cloud communication system.

2. Related Art

Conventionally, a potable device or a computer needs to be authenticated by using an account and a password, and then can communicate with a server of a cloud. This method is very convenient, but for the computer security, once the portable device or the computer is hacked into, the information of the entire cloud will be unguarded. Besides, even if the cloud server is authenticated, the information security still can not be guaranteed, so that the information in the cloud will be stolen at one time, once the cloud server is hacked.

Therefore, it is an important subject to provide a multi-cloud communication system in which the communication mechanism is improved so that the information in the cloud can be transmitted and protected securely.

### SUMMARY OF THE INVENTION

In view of the foregoing subject, an objective of the invention is to provide a multi-cloud communication system in which the communication mechanism is improved so that the information in the cloud can be transmitted and protected securely.

To achieve the above objective, a multi-cloud communication system of the invention includes a plurality of clouds, each of which has a cloud server and a plurality of servers connected with the cloud server. The cloud server has a service information of the servers. When a first cloud server of a first cloud transmits a request information to a second cloud server of a second cloud, the second cloud server determines a level relationship between the first and second clouds, and acquires a target data from at least a second server of the second cloud according to the request information and the service information. The target data is encoded according to the level relationship, and then transmitted to at least a first server of the first cloud through the second cloud server and the first cloud server. The first server, according to the level relationship, decodes the encoded target data to obtain the target data.

In one embodiment, the servers include a web server, a file server, a cluster server, a database server, a storage server, a mail server, a printer server, an application program server, an FTP server, or their any combination.

In one embodiment, the level relationship indicates that the first cloud and the second cloud are at the same level.

In one embodiment, the level relationship indicates that the first cloud is one level superior to the second cloud.

In one embodiment, the level relationship indicates that the first cloud is two or more levels superior to the second cloud.

In one embodiment, the level relationship indicates that the first cloud is one level inferior to the second cloud.

In one embodiment, the level relationship indicates that the first cloud is two or more levels inferior to the second cloud.

In one embodiment, the target data is encoded by the second server according to the level relationship of the first cloud relative to the second cloud.

In one embodiment, the target data is encoded by the second server according to the level relationship of the first cloud relative to the second cloud, and then encoded by the second cloud server.

In one embodiment, the target data includes a tag of the level relationship, a tag of time, or their combination.

As mentioned above, in the multi-cloud communication system of the invention, the data transmission between clouds is performed by a cloud server and another cloud server. Accordingly, the servers of the data source and data destination can stay invisible. Besides, not only the management is performed in the data transmission between the clouds, but the data is encoded and decoded according to the various level relationships so that once a certain server is hacked into, the server providing the data still can preserve its entire data. Thereby, the multi-cloud communication system of the invention can achieve the secure data transmission and information protection by the improved communication mechanism.

### BRIEF DESCRIPTION OF THE DRAWINGS

The invention will become more fully understood from the detailed description and accompanying drawings, which are given for illustration only, and thus are not limitative of the present invention, and wherein:

FIG. 1 is a schematic diagram of a multi-cloud communication system of a preferred embodiment of the invention;

FIG. 2 is a schematic diagram showing the level relationships and the encodings of a preferred embodiment of the invention;

FIG. 3 is a schematic diagram of the multi-cloud communication system of a preferred embodiment of the invention applied to a medical multi-cloud; and

FIG. 4 is a schematic diagram of the multi-cloud communication system of a preferred embodiment of the invention applied to a campus administration multi-cloud.

### DETAILED DESCRIPTION OF THE INVENTION

The present invention will be apparent from the following detailed description, which proceeds with reference to the accompanying drawings, wherein the same references relate to the same elements.

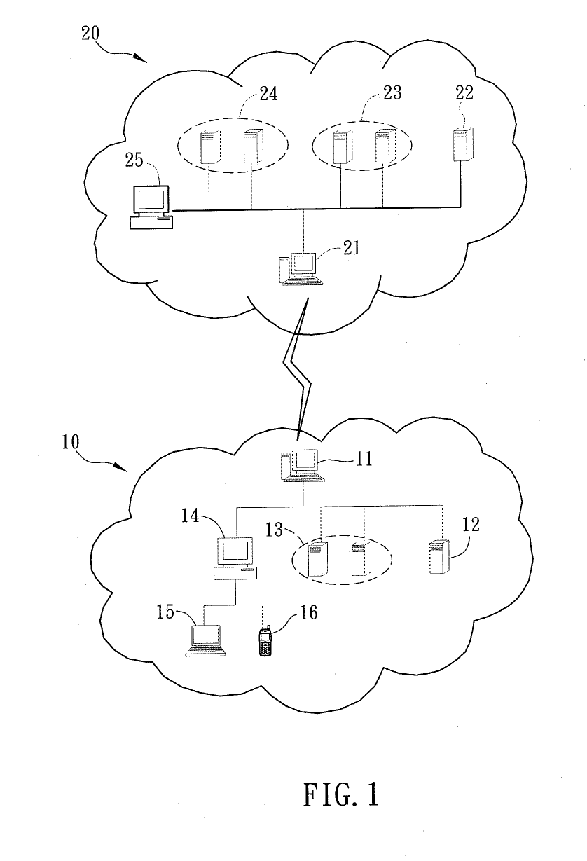

FIG. 1 is a schematic diagram of a multi-cloud communication system of a preferred embodiment of the invention. The multi-cloud communication system includes a plurality of clouds, each of which includes a cloud server and a plurality of servers. The cloud server is connected with the servers, and has a service information of the servers. The multi-cloud communication system in FIG. 1 is illustrated by two clouds communicating with each other for example, but not for limiting the scope of the invention.

As shown in FIG. 1, the multi-cloud communication system includes a first cloud 10 and a second cloud 20. The first cloud 10 includes a first cloud server 11 and a plurality of first servers 12˜14. The first cloud server 11 is connected with the first servers 12˜14 by, for example, a wired network, a wireless network, or their combination. The second cloud 20 includes a second cloud server 21 and a plurality of second servers 22˜25. The second cloud server 21 is connected with the second servers 22˜25 by, for example, a wired network, a wireless network, or their combination.

The first and second cloud servers 11 and 21 are respectively responsible for communicating with other cloud servers of other clouds. For example, the first cloud server 11 communicates with the second cloud server 21. In other words, the first servers 12˜44 of the first cloud 10 don't directly communicate with the second cloud server 21 and the second servers 22˜25 of the second cloud 20, and the second servers 22˜25 of the second cloud 20 don't directly communicate with the first cloud server 11 and the first clouds 12˜14 of the first cloud 10.

Accordingly, the first cloud server 11 has a service information of the first servers 12˜14. The service information contains, for example, service types belonging to the first servers, so that the first cloud server 11 can find the proper one of the first servers to access the desired data. The invention doesn't limit the types of the first servers, which can include a web server, a file server, a cluster server, a database server, a storage server, a mail server, a printer server, an application program server, an FTP server, or their any combination. Herein, the first server 12 is embodied as a file server, the first server 13 is embodied as a cluster server, and the first server 14 is embodied as a web server. Of course, the number of the first servers can be varied according to the practical requirements. Besides, any of the first servers can join or leave the first cloud.

The second cloud server 21 has a service information of the second servers 22˜25. The service information contains, for example, service types belonging to the second servers, so that the second cloud server 21 can find the proper one of the second servers to access the desired data. The invention doesn't limit the types of the second servers, which can include a web server, a file server, a cluster server, a database server, a storage server, a mail server, a printer server, an application program server, an FTP server, or their any combination. Herein, the second server 22 is embodied as a file server, the second server 23 is embodied as a cluster server, the second server 24 is embodied as another web server, and the second server 25 is embodied as a web server. Of course, the number of the second servers can be varied according to the practical requirements. Besides, any of the second servers can join or leave the second cloud.

The multi-cloud communication system and the communication method thereof of this embodiment are further illustrated as below.

The first cloud server 11 sends a request information to a second cloud server 21. To be noted, this embodiment is illustrated by regarding the first cloud server 11 as a data requesting side and regarding the second cloud server 21 as a data providing side, but the inverse case or the coexisting case also can be applied with the multi-cloud communication system and the communication method thereof of this embodiment. In this embodiment, a computer 15 and a smart phone 16 are connected with the first cloud server 11 through the first server (web server) 14. The computer 15 or the smart phone 16 sends a request information through the first server 14, and the first server 14 transmits the request information to the first cloud server 11. The first cloud server 11 determines where the request information should be sent. Herein, because the requested data is stored in the second cloud 20, the first cloud server 11 transmits the request information to the second cloud server 21 for obtaining the desired data. To be noted, the above description can have many varieties. For example, at least one of the computer 15 or the smart phone 16 doesn't connect through the first server 14, but directly connects with the first cloud server 11. Or, the data request doesn't originate from the computer 15 or the smart phone 16, but from the first cloud server 11, which automatically delivers the request information to the second cloud server 21 for the sake of the routine operation for example.

When receiving the request information sent by the first cloud server 11, the second cloud server 21 determines the level relationship between the first and second clouds 10 and 20 as the basis of the following data encoding. The second cloud server 21 also obtains a target data from at least one of the second servers 22˜25 according to the request information and the service information. When the second cloud server 21 receives the request information, it can know, from the service information, which of the second servers stores the target data. For example, the second server (cluster server) 23 stores the target data. Subsequently, the target data can be acquired from the second server 23. To be noted, determining the level relationship and acquiring the target data can be performed at the same time or at different times.

Afterwards, the target data can be encoded according to the determined level relationship. The encoding can be performed by one of the second servers 22˜25 or the second cloud server 21. Herein, the second server 23, the server providing the data, is instanced to encode the target data according to the level relationship.

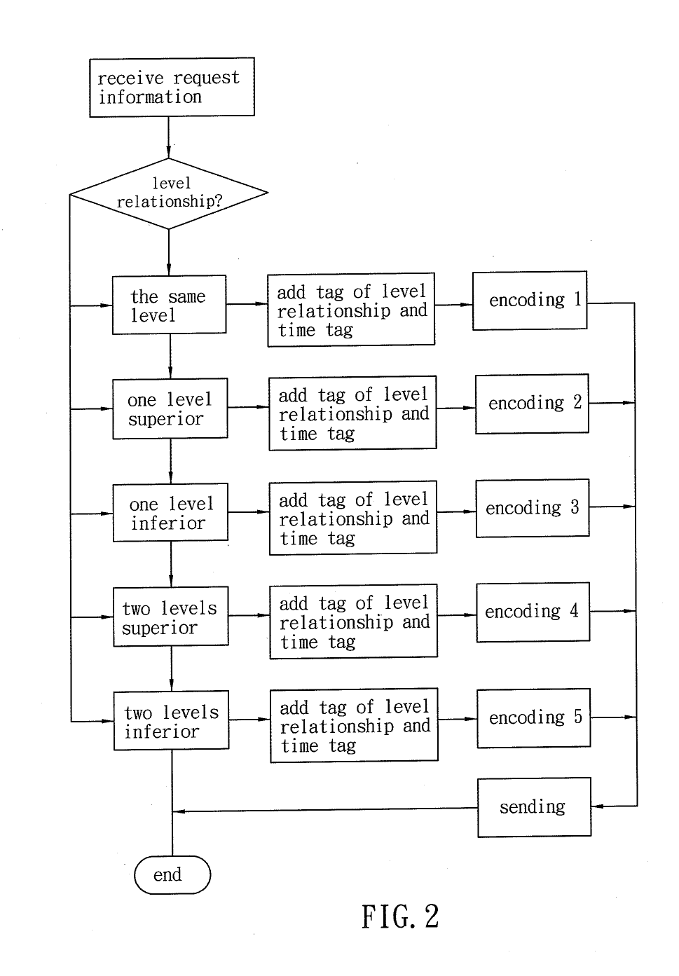

The level relationship can be derived by two aspects. One is depending on the requesting side, and that means the target data is encoded according to the level relationship of the first cloud (requesting side) relative to the second cloud, and the other one is depending on the providing side, and that means the target data is encoded according to the level relationship of the second cloud (providing side) relative to the first cloud. This embodiment is illustrated by the requesting side for example. FIG. 2 is a schematic diagram showing the level relationship and the encoding of a preferred embodiment of the invention. As shown in FIG. 2, the level relationship includes the first and second clouds 10 and 20 being at the same level, the first cloud 10 being one level superior to the second cloud 20, the first cloud 10 being one level inferior to the second cloud 20, the first cloud 10 being two or more levels superior to the second cloud 20, and the first cloud 10 being two or more levels inferior to the second cloud 20. Each level relationship is corresponding to a kind of encoding, such as encoding 1, encoding 2, encoding 3, encoding 4, and encoding 5. To be noted, in other embodiments, two of the level relationships may be corresponding to the same encoding for decreasing the system loading.

Accordingly, the target data is encoded by the second server 23 according to the level relationship of the first cloud 10 relative to the second cloud 20. For example, the first cloud 10 and the second cloud 20 are at the same level so the encoding is performed according to the encoding 1. To deserver to be mentioned, the target data can further include a tag of the level relationship, a tag of time, or their combination. The target data can be provided with a tag of the determined level relationship by the second cloud server 21, and then encoded to become an interne package. The time tag indicates, for example, the time of receiving the request information by the second cloud server 21, or the time of acquiring the target data. The tag of the level relationship and the time tag can be encoded in the encoding of the encoding 1 or in another encoding. The tag of the level relationship is helpful to the following decoding, and the time tag is helpful, for example, to the information management and package identification.

In addition to the encoding performed by the second server 23 according to the level relationship of the first cloud 10 relative to the second cloud 20, the target data can be encoded again. For example, the second encoding of the target data is performed by the second cloud server 21 for enhancing the information protection efficiency.

After encoded, the target data is sent to at least one of the first servers 12˜14 through the second cloud server 21 and the first cloud server 11. When receiving the encoded target data, the first cloud server 11 determines to send the encoded target data to the proper first server for decoding. Of course, if the target data has been secondly encoded by the second cloud server 21, the first cloud server 11 needs to perform the first decoding to the encoded target data and then sends the decoded target data to the proper first server for the second decoding. Herein, the first server 12 is instanced to perform the decoding, and it can know, according to the level relationship stored in the package, the decoding 1 (corresponding to the encoding 1) should be used in the decoding to obtain the target data. After the complete decoding, the first cloud server 11 can send the target data to the corresponding terminal device, such as the computer 15 or the smart phone 16. Besides, the decoding 2 is corresponding to the encoding 2, the decoding 3 is corresponding to the encoding 3, the decoding 4 is corresponding to the encoding 4, and the decoding 5 is corresponding to the encoding 5. These coding/decoding operations have the same principle as the above-mentioned decoding 1, so the detailed descriptions thereof are omitted here.

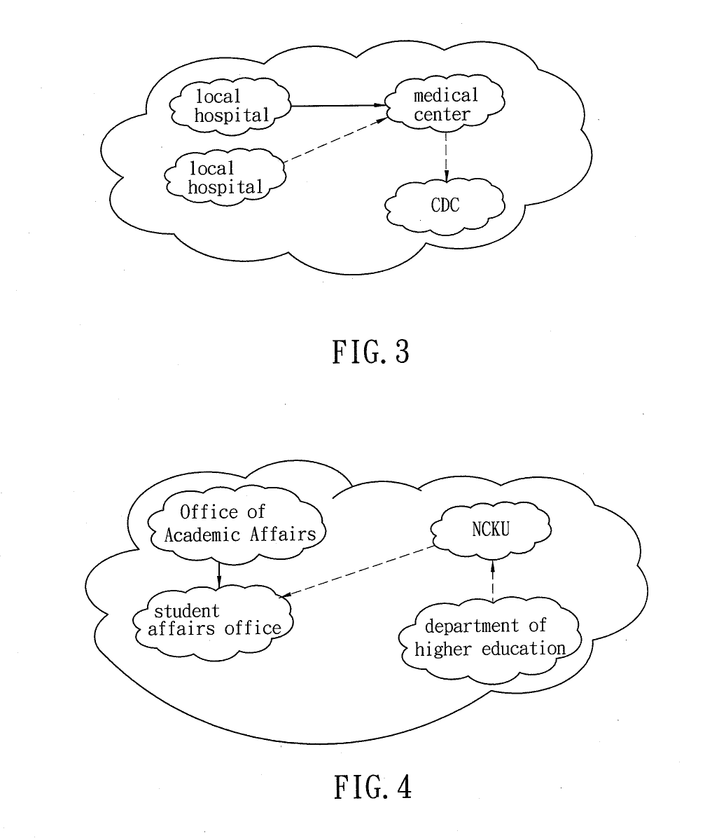

The multi-cloud communication system of the embodiment can be applied to many kinds of fields, such as a medical cloud, a campus administration cloud, etc. FIG. 3 is a schematic diagram of the multi-cloud communication system of the embodiment applied to a medical multi-cloud. As shown in FIG. 3, the medical multi-cloud includes a plurality of local hospitals, a medical center, and Centers for Disease Control and Prevention (CDC). They are connected with each other by a wired network, a wireless network, or the combination thereof for example, and can communicate with each other by transmitting data. For example, one of the local hospitals can function as the first cloud of the above embodiment, the medical center as the second cloud is one level superior to the local hospital, and the CDC as the second cloud is two or more levels superior to the local hospital. In a practical application, a hospital's patient can use a portable device (such as a smart phone) to enter the local hospital's cloud, and find out his own diagnostic records of the hospital (such as chart number, diagnostic date, diagnostic hospital, treating physician, diagnostic medication, outpatients appointment, physician's recommendation, etc.) or the diagnostic records of another hospital's cloud. If a patient needs to transfer from the local hospital to a larger hospital, an attending physician of the larger hospital can look up the data of any hospital of the medical multi-cloud under the patient's permission. Therefore, before the patient reaches the hospital, the attending physician can understand more about the patient's condition with sufficient time to do the correct preparation as soon as possible.

FIG. 4 is a schematic diagram of the multi-cloud communication system of the embodiment applied to a campus administration multi-cloud. As shown in FIG. 4, the campus administration multi-cloud includes an Office of Academic Affairs, a student affairs office, NCKU, and a department of higher education. They are connected with each other by a wired network, a wireless network, or the combination thereof, and can communicate with each other by transmitting data. For example, the student affairs office functions as the first cloud of the above embodiment, NCKU as the second cloud is one level superior to the student affairs office, and the department of higher education as the second cloud is two or more levels superior to the student affairs office. In a practical application, if a student needs to go through a graduation procedure including, for example, ascertaining the credit points (charged by the Office of Academic Affairs), ascertaining borrowing and return of books (charged by the library), or the debt-paying procedure (charged by the register's office), he needs to go to the computer of each of the said units to look up and complete all the procedures for getting the diploma in the past. But now, by the multi-cloud system of the embodiment, all kinds of data can be acquired through a single cloud server, and the data transmission is securely protected, so that the student can complete the entire procedures very soon to get the diploma.

In summary, in the multi-cloud communication system of the invention, the data transmission between clouds is performed by a cloud server and another cloud server. Accordingly, the servers of the data source and data destination can stay invisible. Besides, not only the management is performed in the data transmission between the clouds, but the data is encoded and decoded according to the various level relationships so that once a certain server is hacked into, the server providing the data still can preserve its entire data. Thereby, the multi-cloud communication system of the invention can achieve the secure data transmission and information protection by the improved communication mechanism.

Although the invention has been described with reference to specific embodiments, this description is not meant to be construed in a limiting sense. Various modifications of the disclosed embodiments, as well as alternative embodiments, will be apparent to persons skilled in the art. It is, therefore, contemplated that the appended claims will cover all modifications that fall within the true scope of the invention.

What is claimed is:

1. A multi-cloud communication system, comprising:
a plurality of clouds, each of which comprises a cloud server and a plurality of servers connected with the cloud server, wherein the cloud server has a service information of the servers, when a first cloud server of a first cloud transmits a request information to a second cloud server of a second cloud, the second cloud server determines a level relationship between the first and second clouds, and acquires a target data from at least a second server of the second cloud according to the request information and the service information, the target data is encoded according to the level relationship, and then transmitted to at least a first server of the first cloud through the second cloud server and the first cloud server, and the first server, according to the level relationship, decodes to obtain the target data.

2. The multi-cloud communication system as recited in claim 1, wherein the servers include a web server, a file server, a cluster server, a database server, a storage server, a mail server, a printer server, an application program server, an FTP server, or their any combination.

3. The multi-cloud communication system as recited in claim 1, wherein the level relationship indicates that the first cloud and the second cloud are at the same level.

4. The multi-cloud communication system as recited in claim 1, wherein the level relationship indicates that the first cloud is one level superior to the second cloud.

5. The multi-cloud communication system as recited in claim 1, wherein the level relationship indicates that the first cloud is two or more levels superior to the second cloud.

6. The multi-cloud communication system as recited in claim 1, wherein the level relationship indicates that the first cloud is one level inferior to the second cloud.

7. The multi-cloud communication system as recited in claim 1, wherein the level relationship indicates that the first cloud is two or more levels inferior to the second cloud.

8. The multi-cloud communication system as recited in claim 1, wherein the target data is encoded by the second server according to the level relationship of the first cloud relative to the second cloud.

9. The multi-cloud communication system as recited in claim 1, wherein the target data is encoded by the second server according to the level relationship of the first cloud relative to the second cloud, and then encoded by the second cloud server.

10. The multi-cloud communication system as recited in claim 1, wherein the target data includes a tag of the level relationship, a tag of time, or their combination.
